(19) United States
(12) Patent Application Publication
(10) Pub. No.: US 2015/0292192 A1
(43) Pub. Date: Oct. 15, 2015

(54) DEVICE AND METHOD FOR GRINDING AND RECOVERING DOMESTIC ORGANIC WASTE

(71) Applicant: Solucycle Inc., Quebec (CA)

(72) Inventors: Steve Linteau, Quebec (CA); Matthieu Linteau, Quebec (CA); Alain Dube, Quebec (CA)

(21) Appl. No.: 14/399,776

(22) PCT Filed: May 7, 2013
(86) PCT No.: PCT/CA2013/050351

§ 371 Date: Feb. 20, 2015

Related U.S. Application Data
(60) Provisional application No. 61/644,705, filed on May 9, 2012.

(51) Int. Cl. E03F 5/14; E03C 1/122; B01D 21/02; E03C 1/266

(52) U.S. Cl. CPC E03F 5/14; E03C 1/2665; E03C 1/1222; B01D 21/02

(57) ABSTRACT

Device and method for grinding and recovering organic waste. The device includes a settling tank that receives an aqueous suspension of organic residue and separates it, by settling, into a liquid phase, a solid phase and a gaseous phase. The settling tank includes at least one settling chamber having an inlet that feeds the aqueous suspension to the chamber, and provided with outlets to discharge the various phases produced. The device may include a grinder, level sensing means for the settling chamber, and heat exchange conduits. The method in connection with the device includes steps of grinding organic waste, guiding the aqueous suspension toward the settling chamber, and settling the aqueous suspension. The steps of discharging are controlled by a main controller electrically connected to the settling tank.

### FIELD OF THE INVENTION

The present invention relates to the treatment and recovery of domestic organic waste, such as table scraps. More particularly, the present invention concerns a device and a method for grinding and recovering domestic organic waste, by separating it into a solid compound, a liquid compound and a gaseous compound, all three being recoverable.

### BACKGROUND

Many countries have implemented systems of sorting waste, and recycling parts of it, as a model of sustainable management. However, the management of organic waste remains a major issue. Organic waste is most often treated in water treatment plants or disposed of in landfills. When it decomposes, organic waste emits large quantities of methane, a greenhouse gas that is twenty times more harmful than carbon dioxide. Moreover, the cost of transporting this organic waste to landfills, in garbage trucks, typically accounts for over half the budget allocated by municipalities for the treatment of waste.

Organic domestic waste may be collected through the municipal sewer system, that receives sanitary waste and organic domestic waste, such as vegetable, meat or oil residues, which are preferably ground. The typical manner of treating organic domestic waste by grinding is to pour it in a sink provided with a grinder. The grinder is activated by user, and the resulting ground residue is discharged in the same manner as the wastewater that flows from the sink toward the municipal sewer system.

The addition of organic domestic waste in the municipal sewer system results in a high concentration of organic and solid compounds suspended in the wastewater. Traditional grinding devices therefore increase the pollution of the wastewater treated in municipal treatment plants. The physicochemical and biological treatments used in these plants must therefore purify a greater volume of wastewater, which is also more polluted, thus increasing equipment and production costs.

Moreover, the high concentration of organic and solid compounds suspended in the wastewater increases the risk of insalubrity, and requires more frequent discharges, when septic tanks are used.

Furthermore, organic waste represents a source of fertilizer and biogas that is reclaimed when properly treated by biomethanization.

There is therefore a need for a technology providing at least one solution to one of the problems and/or disadvantages mentioned above with respect to the recovery of organic waste and its reuse.

### SUMMARY

The present invention relates to a device and a method for grinding and recovering organic domestic waste by settling the ground residue into a liquid compound, a solid compound and a gaseous compound.

According to an optional aspect of the invention, a device is provided for grinding and recovering organic waste. The device includes a grinder adaptable to a sink that produces, by grinding, an aqueous suspension of ground organic residue from the organic waste. The device also includes a settling tank that receives the aqueous suspension of ground organic waste and separates it, by settling, into a liquid phase, a solid phase and a gaseous phase. The settling tank includes at least one settling chamber having an inlet configured to feed the aqueous suspension to the chamber, a liquid outlet for discharging the settled liquid phase, a solid outlet for discharging the settled solid phase and a gas outlet, for discharging the gaseous phase.

According to an optional aspect of the device, the grinder may include a system for adding water, to dilute the ground organic residue in the aqueous suspension and facilitate flowing. The water may be automatically added when the grinder is activated. Optionally, the added water may be grey water.

According to an optional aspect of the device, the settling tank and the grinder are connected through the municipal sewer system.

According to an optional aspect of the invention, a device is provided for recovering organic waste. The device includes a settling tank that receives an aqueous suspension of organic waste and separates it, by settling, into a liquid phase, a solid phase and a gaseous phase. The settling tank includes at least one settling chamber having an inlet configured to feed the aqueous suspension to the chamber, a liquid outlet for discharging the settled liquid phase, a solid outlet for discharging the settled solid phase and a gas outlet, for discharging the gaseous phase. At least one part of the organic waste contained in the aqueous suspension may have previously been ground, with a grinder, for example.

According to an optional aspect of the devices, the settling tank may be buried below ground level so that the settling tank is at the same depth as the municipal sewer system, that is, between 1 and 10 in or 1 and 8 in deep. Alternatively, the settling tank may be at ground level, when climatic conditions permit. Optionally, the settling tank may be installed inside or outside of a building.

According to an optional aspect of the devices, the liquid outlet of the settling chamber is in direct communication with the municipal sewer system, such that the settled liquid phase joins the wastewater for further treatment.

According to an optional aspect of the devices, the solid outlet is in direct communication with a pumping interface, through which the solid phase is pumped out of the settling chamber. Optionally, the pumping interface is at ground level, so that it is accessible to a vehicle provided with a pumping system, such as a vacuum pump.

According to an optional aspect of the devices, the gas outlet is in direct communication with a vent in the municipal sewer system.

According to another optional aspect of the devices, the gas outlet may feed a motor or turbine, to produce electricity and/or heat. Optionally, the gas outlet may supply a thermoelectric power plant or a shared boiler room.

According to an optional aspect of the devices, the settling chamber includes a diversion wall adjacent to the inlet of the chamber and projecting toward a lower portion of the chamber, for diverting the incoming ground organic waste toward the lower portion of the chamber, to prevent said waste from exiting the outlet for the settled liquid phase.

According to an optional aspect of the devices, the inlet of the settling chamber is in direct communication with a vent in the municipal sewer system. This configuration allows the discharge of a part of the aqueous suspension having a low or nonexistent level of organic waste directly into the municipal sewer system, without passing through the settling chamber. This configuration also allows the settling chamber to be fed sanitary waste from the municipal sewer system.

According to an optional aspect of the devices, the device includes at least one viewing port for observing and locating any overfilling problems with the settling chamber. Optionally, the observation window may be configured to allow maintenance or discharging, in order to resolve any located problems.

According to an optional aspect of the devices, the inlet of the settling chamber may be provided with a directional control valve that can be selectively set to open position, also known as “grinding position”, to direct the aqueous suspension of ground organic residue toward the settling chamber. This valve can be set by default to closed position, also known as “flowing position”, to direct the wastewater flowing from the sink toward the municipal sewer system without passing through the settling tank. Optionally, the directional control valve may be automatically set to grinding position when the grinder is activated.

According to an optional aspect of the devices, the settling tank itself may include a plurality of level sensing means in the settling chamber. The settling tank may include at least two sensing means for the liquid phase and at least one sensing means for the solid phase. For example, the settling tank may include at least one upper liquid level sensor for detecting a maximum level of liquid phase, one lower liquid level sensor for detecting a lower level of liquid phase, and one solid level sensor for detecting a maximum level of solid phase.

According to an optional aspect of the devices, the device may also include a main controller electrically connected to a grinder switch to control the activation thereof. The controller may therefore prevent a user from activating the grinder. Alternatively, the main controller may be electrically connected to the settling tank to control its filling and discharging.

According to an optional aspect of the devices, the device may include an individual display unit electrically connected to the main controller indicating the operational state of the device to the user of the grinder.

According to an optional aspect of the devices, the device may include a solid collecting unit receiving the solid phase discharged by the solid outlet of the settling chamber. Optionally, the solid collecting unit may be a composter or a bioreactor.

According to an optional aspect of the devices, the devices may include at least one conduit located on the periphery of the settling chamber and configured to perform a heat exchange with the settling chamber. Optionally, the at least one conduit may feed a heat recovery system or a building, for heating purposes.

According to an optional aspect of the devices, the settling tank may include a plurality of adjacent settling chambers configured so that the settled liquid phase may flow from a first settling chamber toward a last settling chamber. The liquid outlet of one settling chamber is therefore in communication with the adjacent settling chamber, and the liquid outlet of the last settling chamber is in communication with the municipal sewer system.

According to an optional aspect of the devices, the grinder may be a first grinder included in a plurality of grinders, that grinds the organic waste to form an aqueous suspension of ground organic residue that is directed toward the at least one settling chamber.

According to another aspect of the invention, a method is provided for grinding and recovering organic waste. This method includes a step of grinding the organic waste with a grinder to produce an aqueous suspension of ground organic residue and a step of guiding the aqueous suspension toward a settling chamber of a settling tank. The method also includes a step of settling the aqueous suspension to form a liquid phase, a solid phase and a gaseous phase in the settling chamber. The step of guiding toward the settling tank is performed simultaneously with the step of grinding.

According to an optional aspect of the method, the method may include a step of liquid discharge, during which the settled liquid phase exits the settling chamber. Optionally, the step of liquid discharge directs the settled liquid phase from the settling chamber toward the municipal sewer system, to join the wastewater. The step of liquid discharge may be performed simultaneously with the step of settling when the liquid phase reaches a liquid outlet of the settling chamber.

According to an optional aspect of the method, the method may include a step of solid discharge, during which the solid phase is discharged from the settling chamber when the solid phase has reached a maximum solid level. Optionally, the step of solid discharge may be carried out by a vehicle provided with a pumping system, such as a vacuum pump.

According to an optional aspect of the method, the method may include a step of gas evacuation, during which all the gas formed in the settling chamber during the step of settling is evacuated through a vent in the municipal sewer system.

According to an optional aspect of the method, the step of grinding may include adding water, to dilute the ground organic residue in the aqueous suspension and facilitate flowing during the step of guiding. Optionally the water used may be grey water.

According to an optional aspect of the method, the step of guiding may include diverting the aqueous suspension of ground organic residue toward a lower portion of the settling chamber. Optionally, the step of guiding may include diverting a portion of the aqueous suspension having a low or nonexistent amount of ground organic residue toward the municipal sewer system without passing through the settling chamber.

According to an optional aspect of the method, the method may include a step of inspecting through an observation window, to check the operational state of the settling tank and observe the solid level in the settling chamber.

According to an optional aspect of the method, the method may also include a step of controlling with a main controller, in order to control the step of guiding toward the settling tank when the grinder is activated during the step of grinding. The step of controlling may also include controlling with a main controller the step of liquid discharge, solid discharge or a combination of the two. Optionally, the step of controlling may include preventing the step of grinding when a maximum solid level is reached in the settling chamber.

According to an optional aspect of the method, the method may also include a step of recovering the gaseous phase to feed a facility for generating heat or electricity.

According to an optional aspect of the method, the method may also include a step of recovering the heat generated by the solid phase with at least one heat exchange conduit.

According to an optional aspect of the method, the method may also include a step of recovering the solid phase to feed a composter or a bioreactor.

### BRIEF DESCRIPTION OF THE DRAWINGS

The different characteristics of the invention and other optional aspects are illustrated in the following figures.

FIG. 1 is a schematic representation of a device for grinding and recovering organic domestic waste according to an optional aspect of the invention.

FIG. 2 is a schematic representation of an electromagnetic pivoting valve according to an optional aspect of the invention.

FIG. 3 is a schematic representation of a ground-level settling tank according to an optional aspect of the invention.

FIG. 4 is a schematic representation of a buried settling tank according to another optional aspect of the invention.

FIG. 5 is a schematic representation of a buried settling tank according to yet another optional aspect of the invention.

FIG. 6 is a schematic representation of a display unit of the operational state of a device according to an optional aspect of the invention.

FIG. 7 is a schematic representation of a display unit of a device according to another optional aspect of the invention.

FIG. 8 is a perspective view of a building complex including a device according to an optional aspect of the invention.

FIG. 9 is an overhead view of a network of single-family dwelling including a device according to an optional aspect of the invention.

FIG. 10 is a schematic perspective view of a settling tank according to an optional aspect of the invention.

Although the invention is described according to the aspects illustrated in the figures mentioned above, it will be understood that the scope of the invention is not limited to these examples alone. On the contrary, all alternatives, modifications and possible equivalents should be potentially considered.

### DETAILED DESCRIPTION OF THE INVENTION

The present invention relates to a device for grinding and recovering organic waste. It also relates to the grinding and recovering method in connection with this device.

It should be understood that the organic waste considered herein includes organic domestic waste mainly derived from food residues. The organic waste may include meat, vegetable and oil residues. The organic waste may also include residues from sand or wood. The organic waste may further include sanitary waste, also known as bio-waste.

It should also be understood that the term “solid phase” refers to any solid phase which may include a certain percentage of moisture.

It should also be understood that the term “liquid phase” refers to any liquid phase which may include a certain percentage of solid particles.

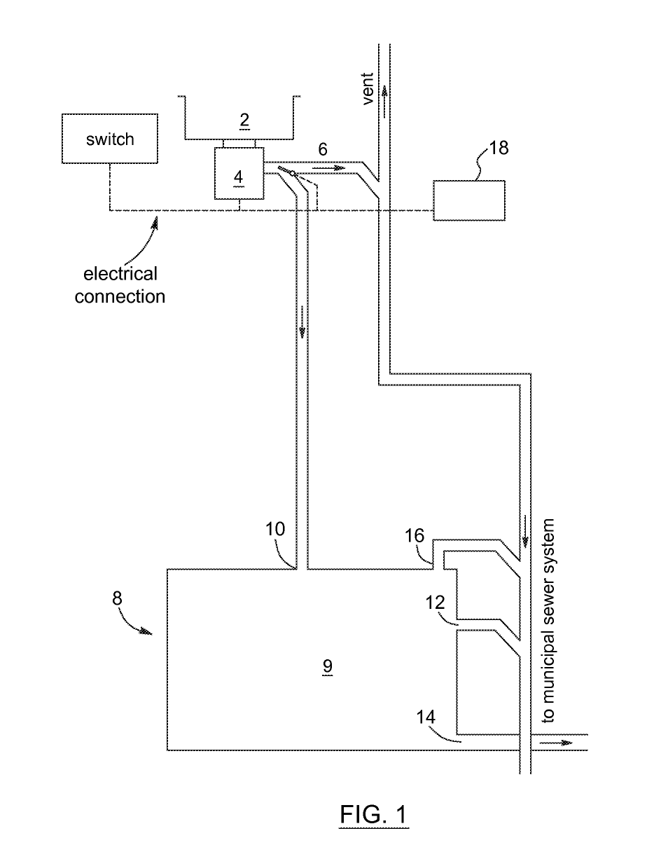

According to FIG. 1, the grinding and recovery device first includes a sink (2) equipped with a grinder (4). The grinder (4) may be provided with a switch, which when activated by a user, grinds the organic domestic waste that the user has previously poured in the sink (4), thereby producing ground organic residue. Water must be added, in order to produce an aqueous suspension of ground organic residue that can flow through sewage pipes. Optionally, the water may be added by a user by letting water flow from a faucet into the sink during the grinding. Also optionally, the water may be added automatically, inside the grinding device, when the grinder is activated. Optionally, the added water may be grey water, that is to say recycled water (rainwater, wastewater, etc.).

In one embodiment, the grinder (4) is in fluid communication with a downstream pipe having a valve, which may be a pivoting valve, such as an electromagnetic pivoting valve (6) as illustrated in FIG. 1. The electromagnetic pivoting valve (6) has two positions: an open position, also known as “grinding position”, and a closed position, also known as “flowing position”. The electromagnetic pivoting valve (6) is in grinding position when the grinder (4) is operating, and in fluid communication with a settling tank (8), to which it is connected. The default position of the valve (6) is the flowing position, in which everything that flows into the sink (2) is directed to the municipal sewer system. Thus, the grinding device grinds the organic domestic waste and produces an aqueous suspension of ground residue which then reaches the valve (6), which is in grinding position, said suspension being directed toward the settling tank (8). The settling tank (8) includes a settling chamber (9) wherein the aqueous suspension of ground residue, by settling, is separated into a liquid phase floating over a solid phase. The solid phase consists of ground organic residue that has sedimented in a lower portion of the settling chamber (9). The settling of the suspension may also result in the release of a gas, also known as a biogas, produced by the fermentation and decomposition of the ground residue. The settling tank (8) includes an inlet (10) that receives the aqueous suspension of ground residue, a liquid outlet (12) for evacuating the liquid phase, a solid outlet (14) for evacuating the solid phase and a gas outlet (16) for evacuating the biogas. The liquid phase and the biogas are preferably evacuated toward the municipal sewer system, which includes a vent for releasing the biogas, and which directs the liquid to municipal water treatment plants. Optionally, the gas outlet (16) may be connected to a biogas collecting chamber which may feed a domestic gas furnace. The device of the present invention also includes a controller (18) electronically connected to the electromagnetic pivoting valve (6) and the settling tank (8).

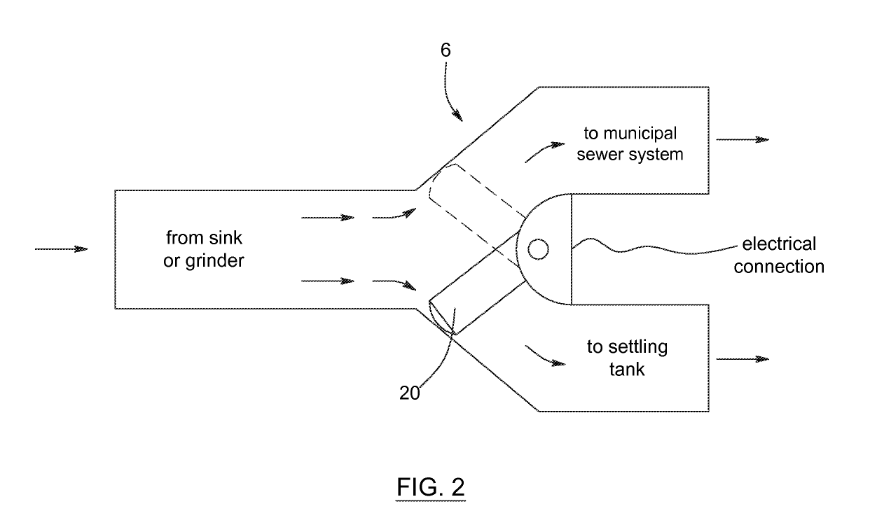

The electromagnetic pivoting valve is illustrated in greater detail in FIG. 2. This valve (6) can be configured in a “Y” shape, which includes a solenoid valve (20) electrically connected to the grinder (4), or its switch, and optionally to the controller (18). The valve (20) moves into grinding position when the grinder (4) is activated, in order to direct the ground waste residue toward the settling tank (8). The default position of the valve (20) is the flowing position, which directs everything that flows from the sink (2) toward the municipal sewer system. The controller (18) can therefore prevent the valve (20) from moving to grinding position when the settling tank contains a maximum amount of solid phase (equivalent to a maximum level of the solid phase in the settling chamber), or when the settling tank is discharged.

It is understood that the device of the present invention is not limited to an electromagnetic pivoting valve, but may include any valve or system for distributing an incoming flow between two available outlets, they may be mechanically or electrically activated.

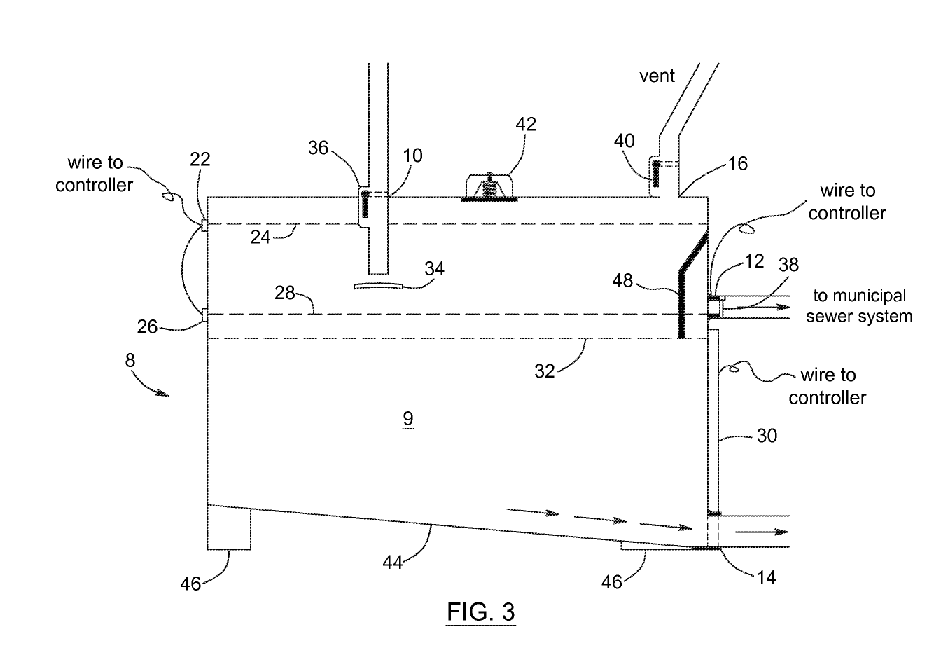

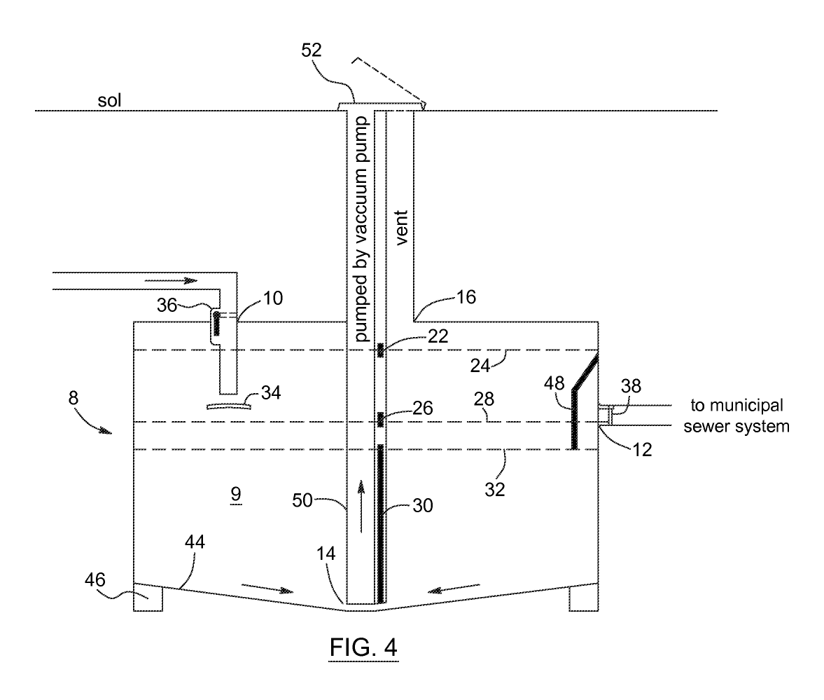

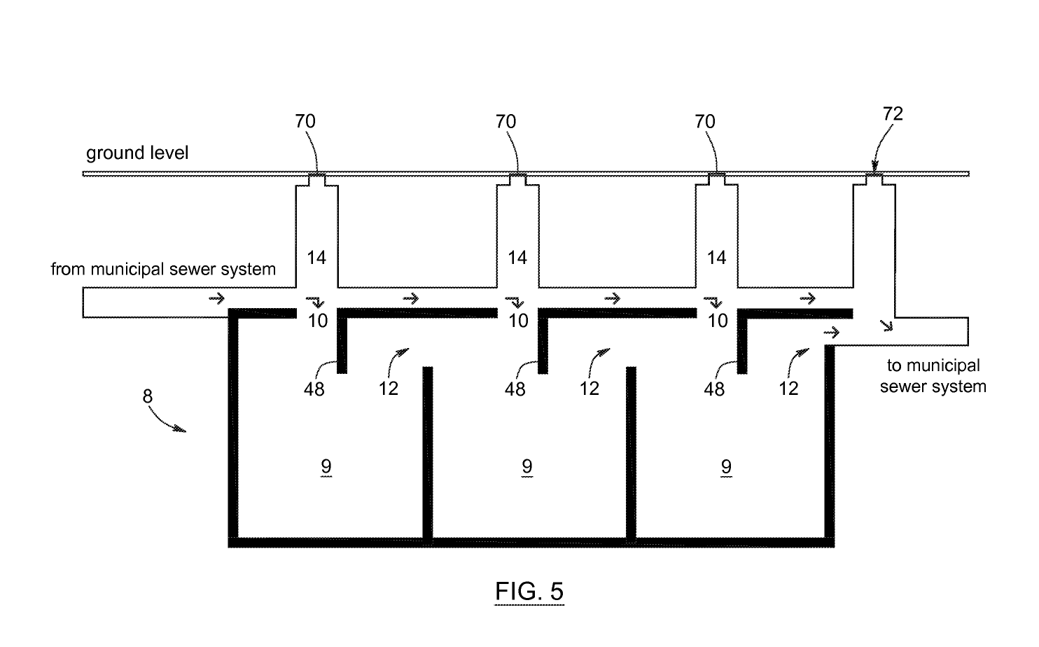

FIGS. 3, 4 and 5 illustrate alternative embodiments of the settling tank according to the present invention. FIG. 3 illustrates a settling tank located at ground level (also called above-ground), and which may be installed inside a building, or outside if local climatic conditions permit. FIGS. 4 and 5 illustrate variations of the device wherein the settling tank is buried below ground level. The essential embodiments and operation of the settling tank remain substantially the same, whether the settling tank is above-ground or below ground.

Referring to FIG. 3, the settling chamber (9) of the settling tank (8) can include multiple level sensors (22, 26 and 30). Sonar level sensors can be used to detect the level of the solid phase, also known as the “solid lever”, and floating level sensors can be used to detect the level of the liquid phase, also known as the “liquid level”. An upper liquid level sensor (22) can optionally be located in an upper portion of the settling chamber (9), in order to detect when the liquid phase reaches a maximum liquid level (24). A lower liquid level sensor (26) can optionally be located in the upper portion of the settling chamber (9), below the upper liquid level sensor (22). The lower liquid level sensor (26) can detect when the liquid phase reaches a lower liquid level (28). The liquid level sensors (22 and 26) can be electrically connected to the main controller (18). A solid level sensor (30) can optionally be located in a lower portion of the settling chamber (9). This sensor (30) can detect when the solid phase reaches a maximum solid level (32). It can also be electrically connected to the main controller (18).

Still referring to FIG. 3, the settling tank (8) may also include a dispersion device (34) located near the inlet (10), which disperses the incoming ground residue in the settling chamber (9). The settling tank (8) may include several closing mechanisms (36, 38 and 40). Indeed, these closing mechanisms (36, 38 and 40) may be useful when draining or performing maintenance on the settling tank (8). The closing mechanisms (36, 38 and 40) are optionally electromagnetic valves. The inlet (10) of the settling tank (8) can include a first electromagnetic pivoting valve (36); the liquid outlet (12) may include a second magnetic pivoting valve (38); and the gas outlet (16) may include a third magnetic pivoting valve (40). It is preferable that the gas outlet, also called the air vent, includes an odor filter to minimize any odors that may be associated with the gas escaping through the outlet (16). The three pivoting valves (36, 38 and 40) may be in an open or closed position. Optionally, the default position of the first and third magnetic pivoting valves (36 and 40) can be an open position, while the default position of the second magnetic pivoting valve (38) can be a closed position, preventing any liquid from escaping through the liquid outlet (12).

Still referring to FIG. 3, the settling tank can also optionally include a vacuum valve (42) located in an upper portion of the settling chamber (9). In order to optimize the evacuation of the solid phase, the settling chamber (9) may have a bottom wall (44) preferably inclined towards the solid outlet (14). The angle of inclination of the bottom wall (44) may be selected so that the solid phase is evacuated by gravity. The settling tank (8) therefore includes at least one support (46) for supporting the inclined bottom wall (44). The liquid outlet (12) optionally further includes a sediment barrier (48) (also referred to as a diversion wall), to prevent any solid particles from the aqueous suspension of ground residue from exiting the liquid outlet (12).

When the aqueous suspension of ground residue enters through the inlet (10) of the settling tank (8), the suspension can optionally be dispersed by a disperser (34), in order to better spread the suspension inside the settling chamber (9). The residue which accumulates in the chamber (9) may begin to settle by separating into a liquid phase floating over a solid phase. The levels of solid phase and liquid phase increase as the grinder (4) provides the aqueous suspension of ground residue. This process corresponds to the normal operation of the settling tank, and is also known as the “running phase”.

When the grinding and recovery device is provided with valves, sensors and control systems, it can operate as follows. When the upper liquid level sensor (22) detects that the liquid phase has reached the maximum level of liquid (24), the main controller (18), to which the sensor (22) is electrically connected, automatically saves the information. The liquid discharge phase is then activated. The main controller (18) then acts on the grinder by preventing it from being activated. The magnetic pivoting valve (6) can no longer move to grinding position, and can only be in flowing position, directing everything from the sink toward the municipal sewer system. Simultaneously, the controller (18) opens a second magnetic pivoting valve (38) to allow a portion of the liquid phase to flow through the liquid outlet (12), preferably to the municipal sewer system. When the lower liquid level sensor (26) detects that the decreasing level of the liquid phase has reached the lower liquid level (28), the controller (18) automatically saves the information. The controller (18) then closes the second magnetic pivoting valve (38) and electrically reconnects the grinder (4) to the magnetic pivoting valve (6) so that the activation of the grinder (4) automatically sets the valve (6) to grinding position, in order to direct the ground residue to the settling tank (8). The liquid discharge phase is now complete, and the grinding and recovery device is returned to normal (or running) phase.

When the solid level sensor (30) detects that the solid phase reaches the maximum solid level (32), the information is automatically recorded by the main controller (18). The settling chamber (9) is then considered full, and discharging of the solid phase, also known as the solid discharge phase, may be carried out. During the solid discharge phase, the controller (18) prevents the grinder from being activated. The valve (6) can no longer move to grinding position and can only be in flowing position, directing everything that flows into the sink toward the municipal sewer system. The controller (18) also closes the first and second magnetic pivoting valves (36 and 38) to close the settling chamber (9) and leave only the solid outlet (14) open. Optionally, the solid outlet (14) is connected to a vacuum pump that sucks the solid phase out of the settling tank (8). The closed first and third magnetic pivoting valves (36 and 40) ensure that the vacuum suction does not damage the upstream elements of the device. In addition, the vacuum valve (42) ensures that the settling chamber (9) does not implode due to the vacuum suction. The vacuum pump may be optionally connected to a residential composter or a municipal organic waste recovery truck.

Referring to FIGS. 4 and 5, the settling tank may optionally be buried below ground level. Preferably, the settling tank is buried deep enough so that its contents cannot freeze, that is, the tank is below what is commonly known as the frost line. The settling tank can be installed below the existing gas pipeline network, and directly adapted directly to the sewage pipes of the municipal sewer system.

According to FIG. 4, the solid outlet (14) can be located at the center of the lower portion of the settling chamber (9), and can extend vertically upwards into a solid outlet conduit (50) which can be closed by a hatch (52) located at ground level. The solid evacuation phase can be performed by connecting a vacuum pump to the solid outlet conduit (50) at a pumping interface, after the hatch (52) is opened. The solid outlet conduit (50) can therefore have an outer surface which has a lower portion in contact with the solid and liquid phases contained in the settling chamber (9). The level sensors (22, 26 and 30) can optionally be disposed along this lower portion of the outer surface of the solid outlet conduit (50).

FIG. 5 shows an alternative embodiment of the device in which the settling tank is buried below ground level and does not include valves, sensors or control systems. The settling tank can be directly connected to the municipal sewer system, and can thus be easily adapted to existing downstream wastewater treatment units in the network.

In some implementations, the settling tank (8) may also include multiple settling chambers (9) in fluid communication with one another. Each settling chamber (9) has an inlet (10), through which the aqueous suspension of ground residue is fed. The aqueous suspension may come from a pipe from the municipal sewage network, the pipe connecting the outlet of the grinder (not shown in FIG. 5) to the inlet (10) of the settling chamber (9). The inlet (10) is optionally located on top of the settling chamber (9).

Through gravity and driving forces, a portion of the aqueous suspension having a high or maximum amount of ground organic residue enters each settling chamber through the corresponding inlet. The remaining portion of the suspension, having a low or nonexistent level of ground organic residue, is propelled into the pipes of the municipal sewer system. In this configuration, the ground residue that has not entered the first settling chamber can enter the subsequent adjacent settling chambers as they are propelled through the pipes of the municipal sewer system.

Referring to FIG. 5, a diversion wall (48) may be located adjacent to the inlet (10) and opposite to the liquid outlet (12), to direct the ground organic waste to the bottom of the settling chamber (9) and prevent it from exiting the liquid outlet (12). In a device with multiple settling chambers, each of the fluid outlets of the first settling chamber and intermediate settling chamber(s) is connected to the next settling chamber. The settling process is extended and improved. If settling cannot be completed in a settling chamber, settling can be further completed when the liquid phase, still having a high solid content, passes to the next settling chamber. The settled solid phase accumulates in each settling chamber (9) of the settling tank (8). A solid outlet (14) may be disposed in alignment with the inlet (10), and be configured as a conduit which extends into the ground to a pump interface (70). A vehicle provided with a pumping device can be connected to this interface (70) in order to carry out the solid evacuation phase for each settling chamber (9). Optionally, the settling tank may include an observation window (72) configured so that it is possible to observe the outlet of the final settling chamber (9), or the interior of each of the settling chambers (9), from ground level. An observer can therefore detect any existing problems, and initiate maintenance or discharge procedures.

It should be understood that the device shown in FIG. 5 may be used in combination with all the elements of the embodiment of this device as shown in FIG. 4, unless there is a clear structural incompatibility.

The ground organic waste may be recovered in order to produce biogas, compost, fertilizer, or to perform any other type of waste reclamation. The device may be easily installed upstream of the municipal sewer system and downstream of the domestic network of a residential dwelling or group of dwellings. The device may advantageously settle the solid waste derived from sanitary waste and discharge it through the pipes of the same municipal sewer system, in communication with the one or more settling chambers.

The number of settling chambers and the size of each chamber depends on several variables, such as the volume of the aqueous suspension exiting the grinder, the amount of ground residue in the aqueous suspension, the number of grinders connected to a same settling tank and the treatment capacity of the municipal sewer system. All these is variables depend on the country where the device is installed, and more specifically, on the municipality or neighborhood where it is installed.

Moreover, the settling time varies according to the dimensions of each settling chamber. The settled solid phase may be discharged from the settling tank on a daily or monthly basis, depending on the usage of the grinder or grinders. The choice of materials for the settling tank and the rest of the device is based on the quality of the surrounding soil or the ambient air.

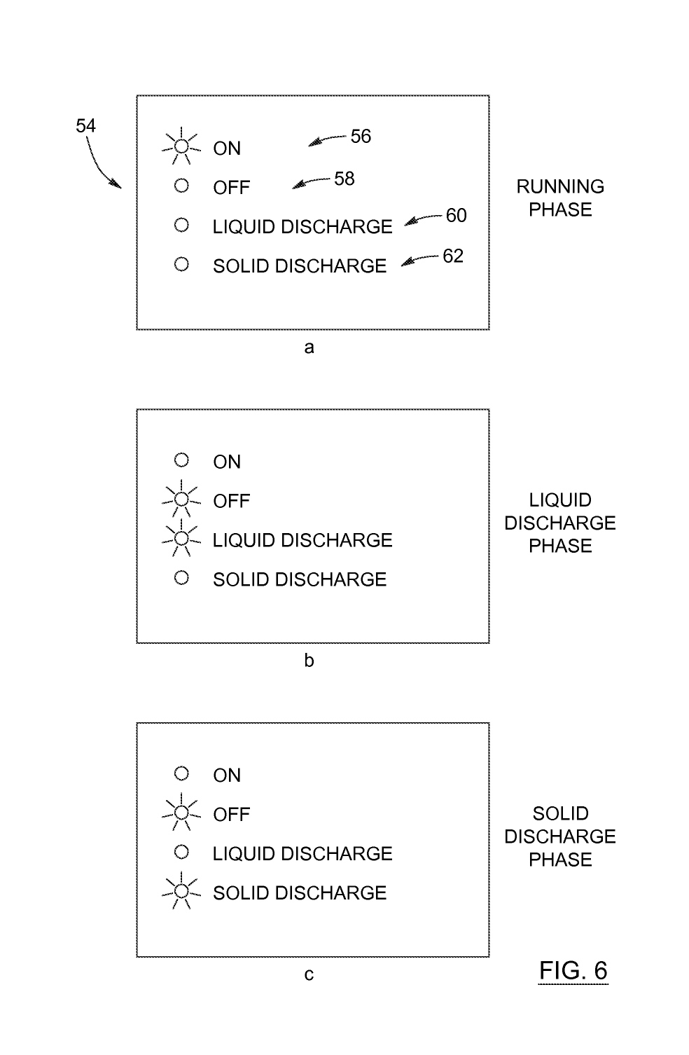

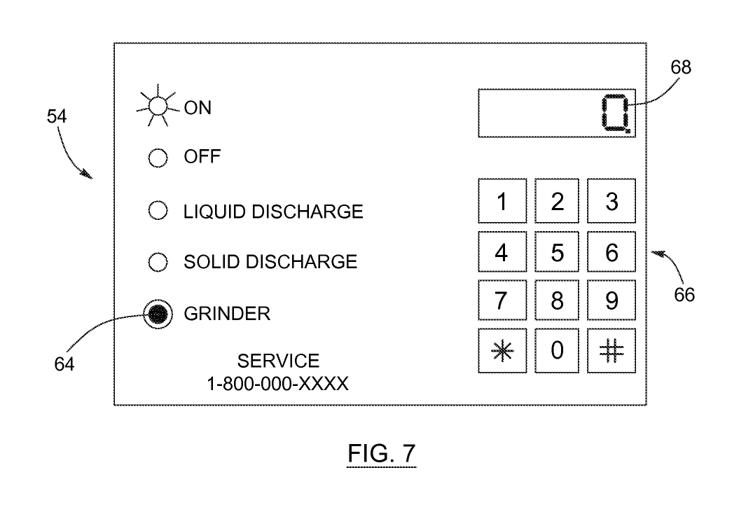

FIGS. 6 and 7 illustrate a display system indicating the operational state of the device for grinding and recovery, according to the present invention. The display system described herein is particularly adapted to devices comprising a directional control valve and level sensing means, as previously described.

According to FIGS. 6 and 7, the device for grinding and recovery according to the present invention optionally includes an individual display unit (54) electrically connected to the main controller (18) and having at least four pilot lights (56, 58, 60 and 62). This display unit may be installed so as to be visible by a user when the grinder is in operation. When the settling tank is in running phase (FIG. 6a), the first pilot light (56) lights up, indicating to the user of the grinder that the tank is in running phase. The electromagnetic pivoting valve can be automatically set to grinding position when this first pilot light (56) lights up, thus directing the ground residue to the settling tank when the grinder is activated. When the settling tank is in liquid discharge phase (FIG. 6b), or when a solid discharge must be performed (FIG. 6c), a second pilot light (58) lights up, indicating to the user of the grinder that the grinder must not be activated. The electromagnetic pivoting valve therefore stays in flowing position. The third and fourth lights (60 and 62) indicate to the user if the grinder is blocked due to a liquid or solid discharge, respectively. When the fourth light (62) is lit, the user can call a city super-intendant or a private service in order to evacuate the solid phase from the tank (8). The user may also optionally use this solid phase himself, for composting. FIG. 7 illustrates a version of the display unit also comprising an activation button (64) for the grinder and a digital keyboard (66), as well as a display unit (68) allowing the user to enter control data or be informed about the parameters of the settling tank.

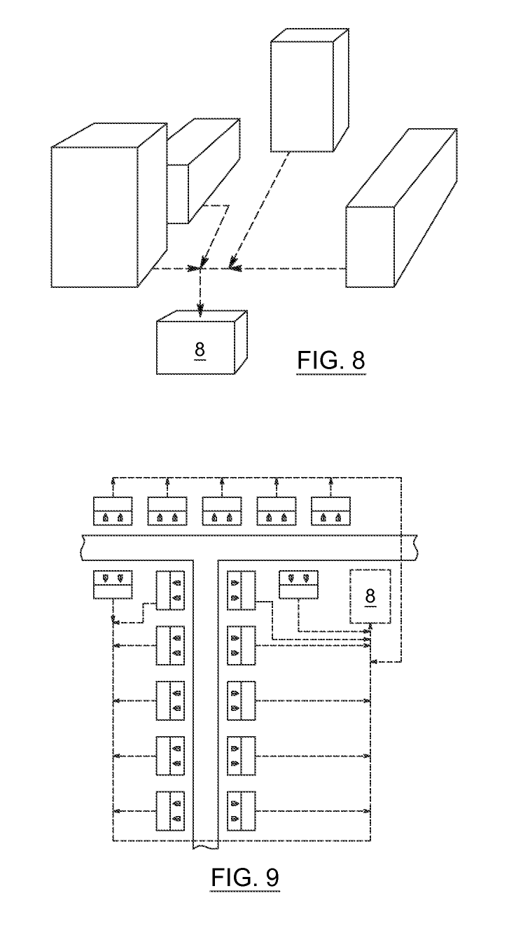

Optionally, the device may be installed in a building including multiple apartments and therefore multiple grinders, connected to a settling tank. According to FIG. 8, the different apartments in a building complex direct their ground waste residue toward a settling tank with an adequate volume capacity. According to FIG. 9, the device may also be installed in a neighborhood with multiple single-family dwellings, that send their ground waste residue toward a nearby settling tank set up for this purpose. A municipal cesspool emptier may then empty the solid phase derived from the organic domestic waste of a whole neighborhood or building at once. Preferably, the neighborhood of multiple single-family dwellings or the building complex is provided with multiple settling tanks. Also preferably, these settling tanks may be in fluid communication with pipes provided for this purpose, and in electric communication with one or more controllers.

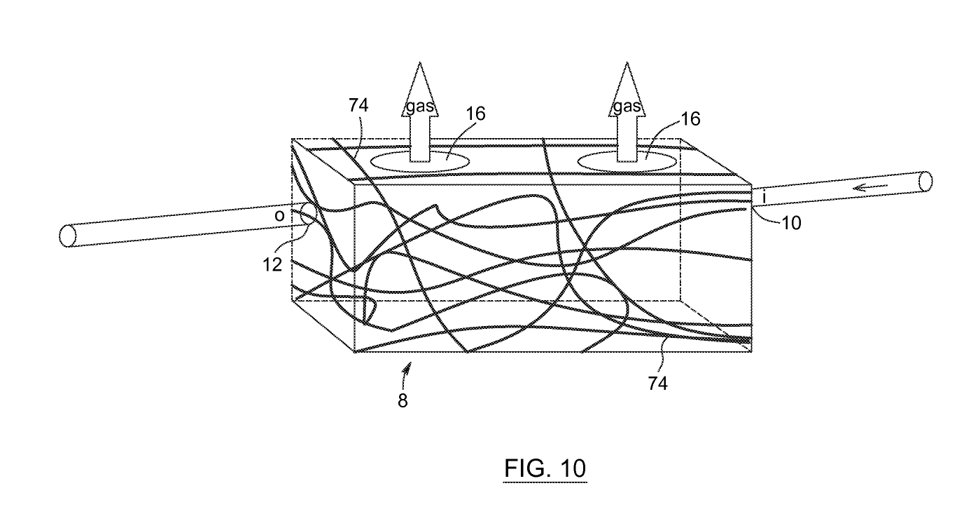

FIG. 10 schematically illustrates the settling tank (8), around whose periphery are disposed conduits (74) allowing the recovery, by heat exchange, of heat produced by the solid matter settled in the one or more settling chambers. The settled solid matter is advantageously at a certain temperature, for example between 11° C. and 18° C., thereby allowing the recovery of the heat produced, by feeding a system for heating or cooling a building, for example.

It should be understood that the present invention includes any device allowing the recovery of settled solid matter or biogas. For example, systems for capturing biogas may be installed in communication with the settling tank in order to collect the biogas produced, which is then sent to a cogeneration unit (heat/electricity), for example. Alternatively, it may be decided not to recover the biogas, and to regularly recover the settled solid matter before it decomposes, in order to feed composters or bioreactors, for example, or use it as a biofuel.

Preferably, the device is installed as part of the construction of a building or a group of buildings that may qualify for LEED certification (Leadership in Energy and Environmental Design), which is awarded to structures having a design and function that is environmentally sound.

1. A device for grinding and recovering organic waste, comprising:
a grinder adaptable to a sink and producing, by grinding, an aqueous suspension of ground organic residue from the organic waste; and
a settling tank receiving the aqueous suspension of ground organic residue and separating it, by settling, into a liquid phase, a solid phase and a gaseous phase, the settling tank comprising:
at least one settling chamber having an inlet configured to feed the aqueous suspension into the chamber,
a liquid outlet for discharging the settled liquid phase,
a solid outlet for discharging the settled solid phase, and
a gas outlet for discharging the gaseous phase.

2. The device according to claim 1, in which the grinder comprises a system for adding water, to dilute the ground organic residue in the aqueous suspension and facilitate flowing.

3. The device according to claim 2, in which the system for adding water is configured so that the water is added automatically when the grinder is activated.

4. The device according to claim 2, in which the water added by the system for adding water is grey water.

5. (canceled)

6. The device according to claim 1, in which the inlet of the settling chamber comprises a directional control valve selectively set to open position, for directing the aqueous suspension of ground organic residue to the settling chamber, or to closed position, for sending all wastewater flowing from the sink to a municipal sewer system, without passing through the settling tank.

7. The device according to claim 6, in which the directional control valve is configured to be automatically set to open position when the grinder is activated.

8.-10. (canceled)

11. A device for recovering organic waste comprising:
a settling tank receiving an aqueous suspension of organic residue and separating said residue, by settling, into a liquid phase, a solid phase and a gaseous phase, the settling tank comprising:
at least one settling chamber having an inlet configured to feed the aqueous solution into the chamber,
a liquid outlet, for discharging the settled liquid phase,
a solid outlet for discharging the settled solid phase, and
a gas outlet for evacuating the gaseous phase.

12. The device according to claim 11, in which at least one part of the organic residue contained in the aqueous suspension has previously been ground.

13.-16. (canceled)

17. The device according to claim 11, in which the liquid outlet of the settling chamber is in direct communication with a municipal sewer system such that the settled liquid phase joins the wastewater for further treatment.

18. The device according to claim 11, in which the solid outlet is in direct communication with a pumping interface through which the solid phase is pumped out of the settling chamber.

19.-22. (canceled)

23. The device according to claim 11, in which the settling chamber comprises a diversion wall adjacent to the inlet of the chamber and projecting toward a lower portion of the chamber, in order to divert the incoming organic residue toward the lower portion of the chamber, to prevent said residue from exiting the outlet for the settled liquid phase.

24.-28. (canceled)

29. The device according to claim 11, in which the settling tank comprises at least one upper liquid level sensor for detecting a maximum level of liquid phase, one lower liquid level sensor for detecting a lower level of liquid phase, and one solid level sensor for detecting a maximum level of solid phase.

30. The device according to claim 11, comprising a solid collecting unit for receiving the solid phase evacuated through the solid outlet of the settling chamber.

31. (canceled)

32. Device according to claim 11, comprising at least one conduit located on the periphery of the settling chamber and configured to perform a heat exchange with the settling chamber.

33.-34. (canceled)

35. A method for grinding and recovering organic waste, the method comprising the steps of:
grinding the organic waste with a grinder to produce an aqueous suspension of ground organic residue,
guiding the aqueous suspension toward a settling chamber of a settling tank, and
settling the aqueous suspension to produce a liquid phase, a solid phase and a gaseous phase in the settling chamber,
in which the steps of guiding the aqueous suspension toward the settling tank and the step of grinding are performed simultaneously.

36. The method according to claim 35, further comprising a step of discharging the settled liquid phase from the settling chamber.

37.-38. (canceled)

39. A method according to claim 35, further comprising a step of discharging the solid phase from the settling chamber when the solid phase reaches a maximum solid level.

40.-41. (canceled)

42. A method according to claim 35, in which the step of grinding comprises adding water to dilute the ground organic residue in the aqueous suspension so as to facilitate flowing during the step of guiding the aqueous suspension.

43. The method according to claim 35, in which the step of guiding comprises diverting the aqueous suspension of ground organic waste toward a lower portion of the settling chamber.

44. The method according to claim 35, in which the step of guiding comprises diverting a part of the aqueous suspension having a reduced or nonexistent level of ground organic residue toward a municipal sewer system without passing through the settling chamber.

45.-51. (canceled)
